(19) United States
(12) Patent Application Publication
(10) Pub. No.: US 2014/0371028 A1
(43) Pub. Date: Dec. 18, 2014

(54) MODULAR GEARBOX ASSEMBLY

(71) Applicant: Plastic Powerdrive Products, LLC., Elk Grove Village, IL (US)

(72) Inventor: Bruce A. Billmeyer, Sleepy Hollow, IL (US)

(21) Appl. No.: 13/944,388

(22) Filed: Jul. 17, 2013

Related U.S. Application Data
(60) Provisional application No. 61/834,248, filed on Jun. 12, 2013.

(51) Int. Cl. F16H 1/46

(52) U.S. Cl. CPC F16H 1/46
USPC 475/337

(57) ABSTRACT

Modular gearbox assemblies, modular gearbox kits, and methods for assembling and for using a modular gearbox assembly are disclosed. A modular gearbox assembly is disclosed which includes one or more gear modules each comprising a gear train encased by a module housing. The gear train includes intermeshed gear elements that provide a predetermined gear ratio. The module housing has one or more coupling elements projecting radially outward therefrom. A gearbox housing stows therein the gear module(s). The gearbox housing has an input coupler for attaching to a driving mechanism and transmitting power output therefrom to the gear module(s). The gearbox housing also has an output coupler for attaching to a driven mechanism and transmitting thereto modified power output from the gear module(s). The gearbox housing has one or more protrusions projecting radially inward therefrom that mate with the coupling element(s) to thereby attach the gearbox housing to the gear module(s).

### CLAIM OF PRIORITY AND CROSS-REFERENCE TO RELATED APPLICATION

This application claims the benefit of and priority to U.S. Provisional Patent Application No. 61/834,248, which was filed on Jun. 12, 2013, and is incorporated herein by reference in its entirety and for all purposes.

### TECHNICAL FIELD

The present disclosure relates generally to gear-based power-transmitting systems. More particularly, the present disclosure relates to modular gearbox assemblies, including both reduction gearboxes and multiplier gearboxes, modular gearbox kits, methods of manufacturing a modular gearbox assembly, and methods of using a modular gearbox assembly.

### BACKGROUND

Gear-based power-transmitting systems are used in numerous applications to manipulate the power output of a driving mechanism, such as the rotational speed and torque of an electric motor, and transmit that manipulated output to a driven mechanism, such as an HVAC compressor or a pump. Conventional motorized vehicles, such as the modern day automobile, for example, include a powertrain that is comprised of an internal combustion engine (ICE) and/or one or more electric motor/generators in power flow communication with a final drive system (e.g., rear differential and wheels) via a multi-speed power transmission. The primary function of the multi-speed power transmission is to regulate speed and torque to meet demands for vehicle speed and acceleration

Another well-known type of gear-based power-transmitting system is the gear reducer which, in its simplest form, is a mechanical device by which the speed and/or torque output of a driving mechanism is reduced. Gear reducers—also commonly referred to as “gearboxes” or “reduction gearboxes”—accomplish the aforementioned reduction in speed/torque by changing the ratio of rotation between two moving, interconnected parts. Many gear reducers employ a number of gear elements, such as epicyclic planetary gear sets, for coupling the gearbox assembly's input and output shafts. The torque ratio (or “mechanical advantage”) and speed ratio offered by any given gearbox is directly correlated to the number of teeth on each of the gears in the gear train.

In today's market, most commercially available motor-driven gear reducers and gearboxes are custom-made to fit each customer's specifications. For example, a customer will typically have a motor with specific dimensions, distinct output capabilities, a particular output shaft configuration, and application-specific performance requirements. As such, the customer is normally required to engineer or purchase a custom-made gearbox assembly to meet the individual characteristics of their motor and intended application of their powertrain assembly. This results in additional research and development (R&D) and increased manufacturing time, which leads to increased overhead costs and delayed time to market.

### SUMMARY

According to aspects of the present disclosure, a motor-independent modular gearbox assembly is provided (as used herein, “gearbox” can refer to both reduction gearboxes and multiplier gearboxes). The modular gearbox assembly includes interchangeable planetary-gear inserts (or “gear modules”) that can be selected and arranged to meet the performance specifications of any motor manufacturer. The outer housing is designed to stow and couple with any assortment of these interchangeable inserts, e.g., to provide an endless variety of speed and torque ratios. In addition, the outer housing can be designed to stow and couple with any number of interchangeable inserts, e.g., to offer 1-stage gearboxes, 2-stage gearboxes, 3-stage gearboxes, etc. The modular gearbox assembly can include a flexible beam coupler which allows the gearbox to operatively couple to the output shaft of any motor assembly.

These features offer significant flexibility to use the disclosed gearbox designs for a variety of applications and with a variety of motors. Notable advantages of some of the disclosed concepts include reduced engineering time and costs to research and develop a desired gearbox assembly, as well as decreased manufacturing and assembly time and costs for fabricating the desired gearbox assembly, all of which lead to reduced overhead costs and faster time to market. Other advantages include simplicity of assembly, use and repair, increased flexibility and scalability, and reduced repair times and warranty costs.

Aspects of the present disclosure are directed to a modular gearbox assembly for transmitting the power output of a driving mechanism to a driven mechanism. The modular gearbox assembly includes one or more gear modules, each of which comprises a gear train encased by a module housing. The gear train of each gear module includes a plurality of intermeshed gear elements that cooperatively provide a predetermined gear ratio. The module has an outer periphery with one or more coupling elements projecting radially outward therefrom. The modular gearbox assembly also includes a gearbox housing that stows therein the one or more gear modules. The gearbox housing has an input coupler configured to attach to the driving mechanism and transmit the power output therefrom to the gear module(s) such that the power output is modified by the gear module(s). The gearbox housing also has an output coupler configured to attach to the driven mechanism and transmit thereto the modified power output from the gear module(s). The gearbox housing has an inner surface with one or more protrusions projecting radially inward therefrom. The one or more protrusions of the gearbox housing mate with the one or more coupling elements of the module housing(s) to thereby retain the one or more gear modules inside the gearbox housing.

In accordance with other aspects of the present disclosure, a kit is featured for assembling a gearbox assembly operable to receive, modify and transmit the power output of a driving mechanism, such as an electric motor. The kit includes a plurality of self-contained gear modules, each of which comprises a gear train encased by a module housing. The gear train, which may be in the nature of a planetary gear set, includes two or more intermeshed gear elements that cooperatively provide a predetermined gear ratio. The module housing has one or more coupling elements projecting radially outward therefrom. The kit also includes a gearbox housing configured to stow therein any one or more of the self-contained gear modules. The gearbox housing has an input coupler for attaching to the driving mechanism and transmit the power output therefrom to the one or more gear modules such that the power output is modified by the gear module(s). The gearbox housing also has an output coupler for outputting from the gearbox housing the modified power output. The gearbox housing has an inner surface with one or more protrusions projecting radially inward therefrom. The one or more protrusions of the gearbox housing are configured to mate with the one or more coupling elements of the module housing(s) to thereby retain the one or more gear modules inside the gearbox housing.

Other aspects of the present disclosure are directed to a method for assembling a gearbox assembly operable to receive power output from a driving mechanism, modify the power output, and transmit the modified power output to a driven mechanism. The method includes: identifying a desired gearbox gear ratio; selecting one or more of a plurality of preassembled, self-contained gear modules that have been determined to provide the desired gearbox gear ratio, each of the self-contained gear modules comprising a gear train encased by a module housing, the gear train including two or more intermeshed gear elements providing a predetermined gear ratio, the module housing having one or more coupling elements projecting radially outward therefrom; selecting one of a plurality of gearbox housings that has been determined to be configured to stow therein the selected self-contained gear module(s), the gearbox housing having an inner surface with one or more protrusions projecting radially inward therefrom, the one or more protrusions being configured to mate with the one or more coupling elements of the module housing(s) to thereby retain the gear module(s) in the gearbox housing; inserting the selected self-contained gear module(s) into the gearbox housing such that the gear module(s) successively mechanically couple with one another and such that the one or more coupling elements mate with the one or more protrusions; and, attaching at least one lid to at least one end of the gearbox housing.

The above summary is not intended to represent each embodiment or every aspect of the present disclosure. Rather, this summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a partially exploded perspective-view illustration of a representative 3-stage spur-gear-type modular gearbox assembly according to aspects of the present disclosure.

FIGS. 2A-2C are front-view, side-view and rear-view illustrations, respectively, of the modular gearbox assembly of FIG. 1.

FIG. 3 is a partially exploded perspective-view illustration of selected segments of the planetary gear train of FIG. 1.

FIG. 3A is a partially exploded perspective-view illustration of one of the planetary gear modules of FIG. 1.

FIG. 4 is a perspective-view illustration of the modular gearbox assembly of FIG. 1 shown assembled and partially cutaway to better illustrate the internal arrangement of the gearbox assembly.

FIG. 5 is a partially exploded perspective-view illustration of a representative 3-stage bevel-gear-type modular gearbox assembly according to aspects of the present disclosure.

FIGS. 6A-6C are front-view, side-view and top-view illustrations, respectively, of the modular gearbox assembly of FIG. 5.

FIG. 7 is a partially exploded perspective illustration of selected segments of the gear train of FIG. 5.

FIG. 8 is a partially exploded perspective-view illustration of a representative 2-stage spur-gear-type modular gearbox assembly according to aspects of the present disclosure.

FIG. 9 is a partially exploded perspective-view illustration of a representative 2-stage bevel-gear-type modular gearbox assembly according to aspects of the present disclosure.

FIG. 10 is a partially exploded perspective-view illustration of a representative 1-stage spur-gear-type modular gearbox assembly according to aspects of the present disclosure.

FIG. 11 is a partially exploded perspective-view illustration of a representative 1-stage bevel-gear-type modular gearbox assembly according to aspects of the present disclosure.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

Disclosed herein are various representative motor-driven modular gearbox assemblies, modular gearbox kits, as well as methods of making and methods of using a modular gearbox assembly (as used herein, “gearbox” can refer to both reduction gearboxes and multiplier gearboxes). For some embodiments, the gearbox assembly is a power transmitting gear reducer. The modular gearbox assembly includes interchangeable planetary-gear inserts (also referred to herein as “gear modules” or “stages”) that can be selectively and removably coupled together (e.g., stacked one on top of the other) to meet the performance specifications of any motor manufacturer. Each stage can be clipped or otherwise mechanically fastened together using one or more conventional mechanical fasteners. Optionally, the individual stages, once properly aligned with and inserted into the outer housing, can be bonded together (e.g., via adhesives) or welded together (e.g., via sonic welding). The interchangeable stages can be rearranged or replaced, for example, to provide alternative performance characteristics or as a means of fixing a defective gearbox assembly.

The outer housing of the modular gearbox assembly can be “universal” in that it is configured to receive, couple with, and stow any assortment of the interchangeable planetary-gear inserts, e.g., to provide an endless variety of speed and torque ratios. The housing size can also be changed to allow for greater or fewer stages—e.g., 1 stage, 2 stage, 3 stage, 4 stage, etc. The housing size can also be modified to allow for larger or smaller planetary-gear inserts. The outer housing can be fabricated from any known material to have sufficient rigidity and desired structural characteristics for the intended application of a gearbox assembly. In at least some aspects of the disclosed concepts, the housing may be formed from polyoxymethylene (POM) or other acetal plastic. For some desired implementations, the housing is fabricated, in whole or in part, from a mineral-filled nylon or other type of moldable plastic, for example, to help ensure that a range of temperatures and vibrations can be accommodated. In some embodiments, acetal plastic filled with Teflon or silicone or other known fillers is used for the gears modules and/or gear members.

The modular gearbox assembly can include a flexible beam coupler or other input mechanism which allows the gearbox to operatively couple to the output shaft of any motor assembly. The flexible beam coupler, which may be in the nature of a spiral beam coupler, can be configured to attach to a shaft with up to a 12 degree angular velocity. The modular gearbox assembly can include a flexible beam coupler or other output mechanism which allows the gearbox assembly to operatively couple to the input shaft or input mechanism of any driven mechanism.

For some configurations, the modular gearbox assembly includes one or more endplates (or “lids”) attached to and closing off one or more ends of the gearbox housing. In one example, a motor mounting plate can be coupled to an input end of the gearbox outer housing via one or more bolts. For some configurations, the motor mounting plate can be coupled to the outer housing via one or more clips, snap fasteners, or other mechanical fasteners. In this regard, an output lid can be attached to and close off an output end of the gearbox housing on the opposite side of the input end where the motor mounting plate is attached.

If a customer has a different output torque or speed requirement, or a different input torque or speed requirement, the disclosed assembly allows for selective modification of one or more of the individual stages (as opposed to the custom fabrication of the entire assembly). For instance, the width, the pitch, the material, etc., for one or more of the stages can be adapted to a customer's individual specifications.

In some embodiments, the entire assembly or substantially the entire assembly is fabricated from plastic or other known polymeric and synthetic materials, such as the aforementioned POM plastic. For some embodiments, one or more components can be overmolded or undermolded with plastic. Optionally, one or more components can be fabricated, in whole or in part, from metallic materials. For instance, the first and second stages of the gearbox assembly can be fabricated entirely or predominantly from metal. In a high-torque application and/or applications with an initial startup of a higher RPM or high startup input torque, the first stage or the first few stages can be fabricated entirely or predominantly from metal, and the subsequent stages can step be fabricated entirely or predominantly from plastic.

It may be desirable for some configurations to be compatible with National Electrical Manufacturers Association (NEMA) size motors 23 and down. Some configurations are compatible with motor sizes that are higher than NEMA size 23. In addition, the modular gearbox assembly can be scalable—i.e., it can take on various shapes and sizes. By way of example, the gearbox can be 1 square inch, 2 square inches, or larger. Optionally, the gearbox outer housing can be polyhedral (e.g., box shaped), toroidal (e.g., cylindrical), spherical, or other shape, as may be desired or required by a customer's intended application.

Various gearbox assemblies are disclosed herein, including 1-stage, 2-stage and 3-stage gearboxes. The gearbox assemblies can comprise any number or combination of parts, sub-assemblies, and/or assemblies described above and/or depicted in the accompanying figures. The gearbox assemblies can include a single gear type or any assortment of gears, including spur gears, helical gears, bevel gears, spiral gears, worm gears, etc. The present concepts also include various gearbox kits, which may comprise any number of, or combination of, parts, sub-assemblies, and/or assemblies described herein and/or depicted in the accompanying figures, in whole or in part.

The present concepts also include methods of assembling a gearbox assembly. For example, a method of assembling a gearbox assembly may include: providing a plurality of interchangeable planetary-gear inserts, each comprising a respective gear ratio and/or a respective torque ratio; providing a housing configured to receive therein and attach to any combination of the interchangeable planetary-gear inserts; determining which of the plurality of interchangeable planetary-gear inserts are required to provide a desired mechanical advantage (e.g., output speed and/or output torque); inserting the determined interchangeable planetary-gear inserts into the housing such that the inserts are concentrically aligned with and operatively connected to each other; and, attaching one or more end plates to the housing. In addition, the present concepts also encompass methods of manufacturing a gearbox assembly as well as methods of using a gearbox assembly.

Numerous representative embodiments, options, features and alternatives are presented in various forms in the following discussion and corresponding figures. Each of these options and features, and other now known and hereinafter developed options and features, can be incorporated into any of the disclosed embodiments unless explicitly disclaimed or otherwise logically prohibited. By way of non-limiting example, the elements, options, features and alternatives described below with respect to 3-stage modular gearbox assemblies, whether spur-gear-type assemblies or bevel-gear-type assemblies, can be incorporated into the disclosed 2-stage and 1-stage embodiments, and vice versa, without departing from the intended scope and spirit of the present disclosure.

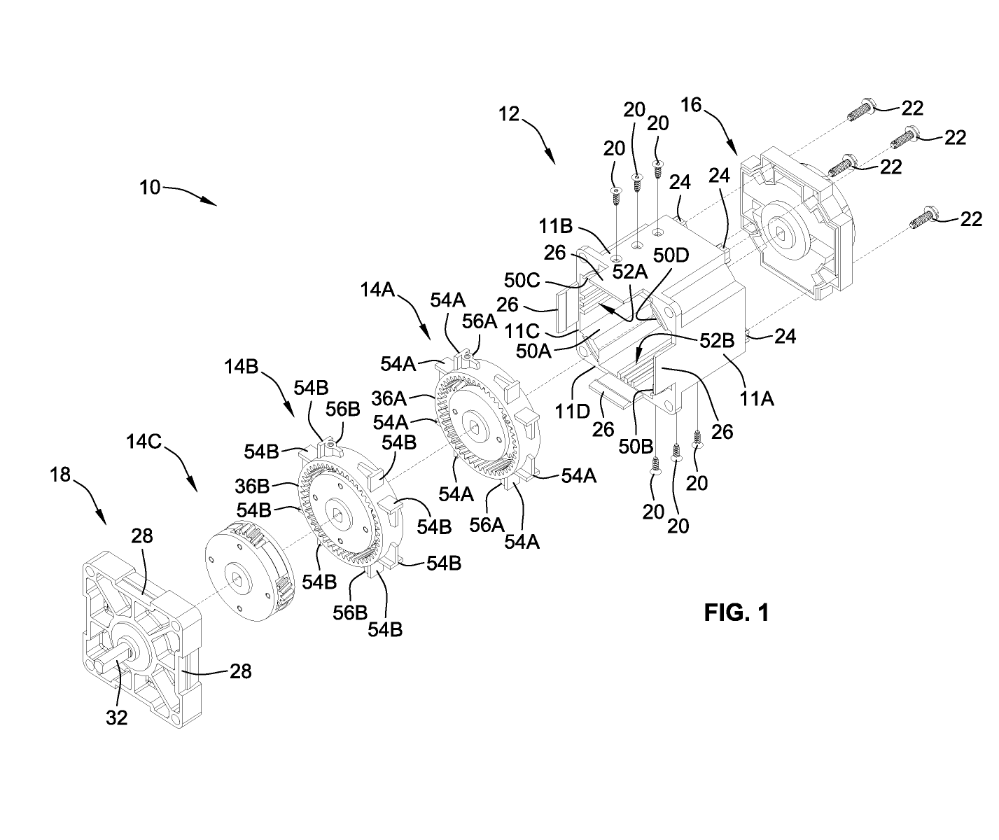

Referring now to the drawings, wherein like reference numbers refer to like components throughout the several views, there is shown in FIG. 1 a representative modular gearbox assembly, designated generally as 10, in accordance with aspects of the present disclosure. The modular gearbox assembly 10 presented in FIG. 1, the illustrated components of which may be representative of some of the components included in a representative gearbox kit in accordance with the present disclosure, is described herein in the context of a 3-stage spur-gear-type reduction gearbox assembly to offer a representative application by which some of the aspects and features of the present invention may be incorporated and practiced. Accordingly, the present invention is by no means limited to the particular configuration illustrated in FIG. 1. By way of example, and not limitation, aspects and features disclosed in FIG. 1 can be incorporated into the 1-stage and 2-stage spur-gear-type assemblies illustrated in the drawings, as well as any of the bevel-gear-type modular gearbox assemblies illustrated in the drawings. In addition, the drawings presented herein are not necessarily to scale and are provided purely for explanatory purposes. Thus, the individual and relative dimensions shown in the drawings are not to be considered limiting unless explicitly stated otherwise in the claims.

In the embodiment presented in FIG. 1, the modular gearbox assembly 10 includes a rigid outer housing 12 (also referred to herein as “gearbox housing”) with a plurality of sidewalls 11A-11D that are interconnected to define therebetween a mounting space within which are mounted and stowed one or more planetary-gear inserts (or “stages”)—i.e., first, second and third gear modules 14A, 14B and 14C, respectively. Although alternative shapes are certainly envisioned as being within the scope of the present disclosure, the gearbox housing 12 of FIG. 1 is portrayed as having a polyhedral “box-shaped” geometry with four generally rectangular side faces and two generally square end faces. It is envisioned that the gearbox housing 12 may include greater or fewer than six faces, each of which may take on a different size and/or shape than that which is shown in the drawings. The gearbox housing 12 is desirably fabricated from a rigid and resilient material, which may include, but is not limited to, metals (e.g., aluminum and steel), plastics and polymeric materials (e.g., acetal, polyvinyl chloride (PVC), and polyethylene terephthalate (PET), etc.), glass-fiber composites, etc. It is desirable, for at least some embodiments, that the sidewalls 11A-11D be integrally formed together to form a single-piece, unitary structure in the manner shown. Alternatively, two or more of the sidewalls 11A-11D may be formed as separate constituent parts that are thereafter coupled together, for example, via welding, adhesives or mechanical fasteners.

Attached at an input (“front”) end of the gearbox housing 12 is a motor mounting lid 16, while attached on the opposite side of the gearbox housing 12 at an output (“rear”) end thereof is an output lid 18. As shown, the motor mounting lid 16 is attached to the gearbox housing 12 via one or more threaded fasteners, which may be in the nature of four flat-head bolts 22, each of which passes through a corresponding slot (not visible in the views provided) in the motor mounting lid 16 and into a complementary threaded anchor 24 (three of the four of which can be seen in FIG. 1) that projects forward from the front end of the gearbox housing 12. As an optional feature, the threaded anchors 24 are configured (e.g., shaped and positioned) to ensure that the motor mounting lid 16 is properly aligned with and securely seated against the housing 12 before it is rigidly fastened thereto via the bolts 22. Comparatively, the output lid 18 is attached to the gearbox housing 12 via one or more mechanical couplings, which may be in the nature of four circumferentially spaced snap fasteners 26, each of which projects rearward from the back end of the gearbox housing 12, then passes over the ramped surface of and latches onto a complementary recess 28 (only two of the four of which are visible in FIG. 1) on the outer periphery of the output lid 18. It should be readily recognized that alternative means for attaching the lids 16, 18 to the gearbox housing 12 (e.g., rivets, welding, machining, etc.) are well within the scope of this disclosure. In this regard, one or more threaded fasteners (e.g., screws or bolts) can be employed to attach the output lid 18 to the gearbox housing 12 as an additional or alternative means to the snap fasteners 26. Likewise, the bolts 22 used to attach the motor mounting lid 16 to the housing 12 can be replaced by or supplemented with one or more mechanical couplings, which may be similar to the snap fasteners 28. Optionally, one of the lids 16, 18 can be integrally formed with the gearbox housing 12. Once attached, each lid 16, 18 at least partially (and, in some embodiments, substantially or completely) covers a respective open end of the gearbox housing 12 such that the lids 16, 18 cooperatively secure the gear modules 14A-C inside the housing 12.

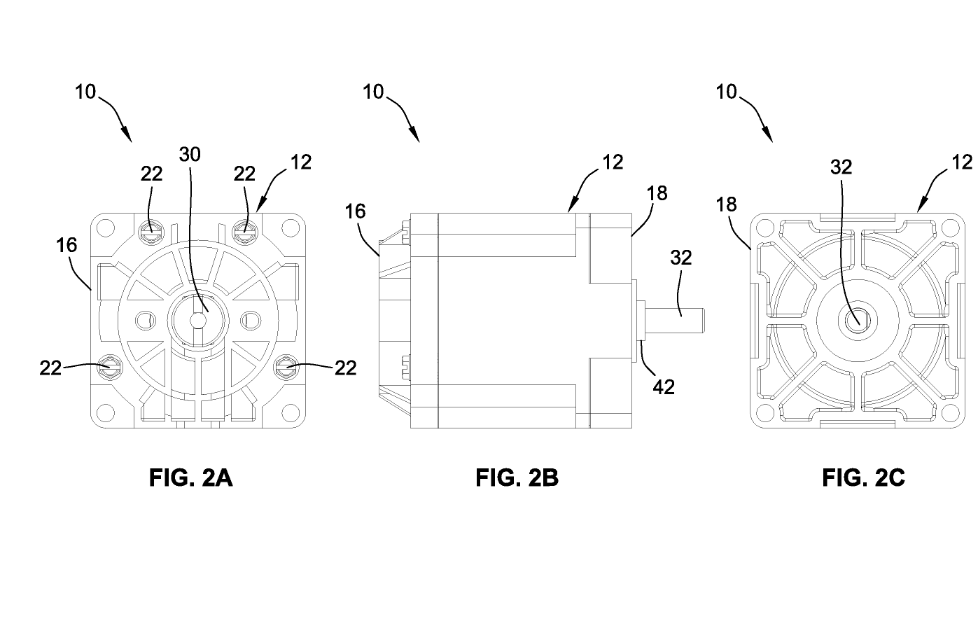

As an input member, the modular gearbox assembly 10 includes an input coupler 30 (FIGS. 2A, 3 and 4) for operatively attaching the gearbox assembly 10 to a driving mechanism, such as a motor, engine or other device capable of outputting rotational power, and transmitting the power output (e.g., torque and rotational speed) from the driving mechanism to the one or more gear modules 14-C stowed inside the gearbox housing 12. As an output member, the modular gearbox assembly 10 includes an output coupler 32 for operatively attaching the modular gearbox assembly 10 to a driven mechanism, such as an HVAC compressor, a pump, or a final drive of an automobile, and transmitting thereto the modified power output provided by the gear module(s) 14A-C stowed inside the gearbox housing 12. While a variety of alternative designs and configurations are envisioned as being within the scope of this disclosure, the input coupler 30 of the illustrated embodiment is a toroidal flexible beam coupler while the output coupler 32 of the illustrated embodiment is a keyed shaft.

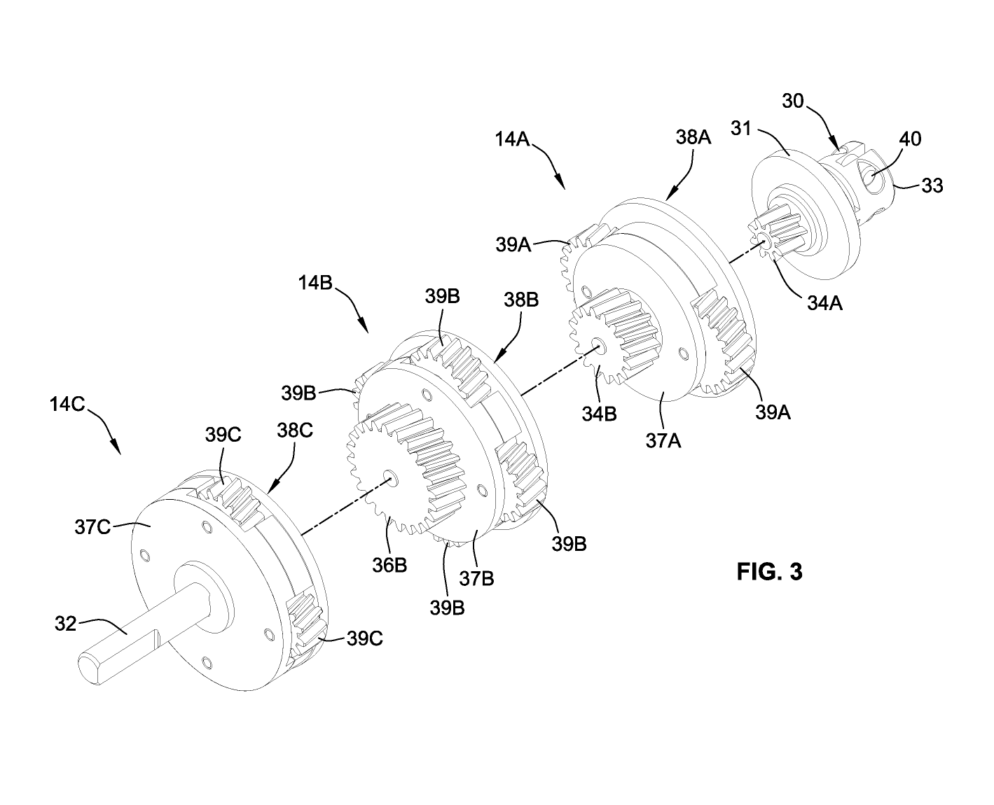

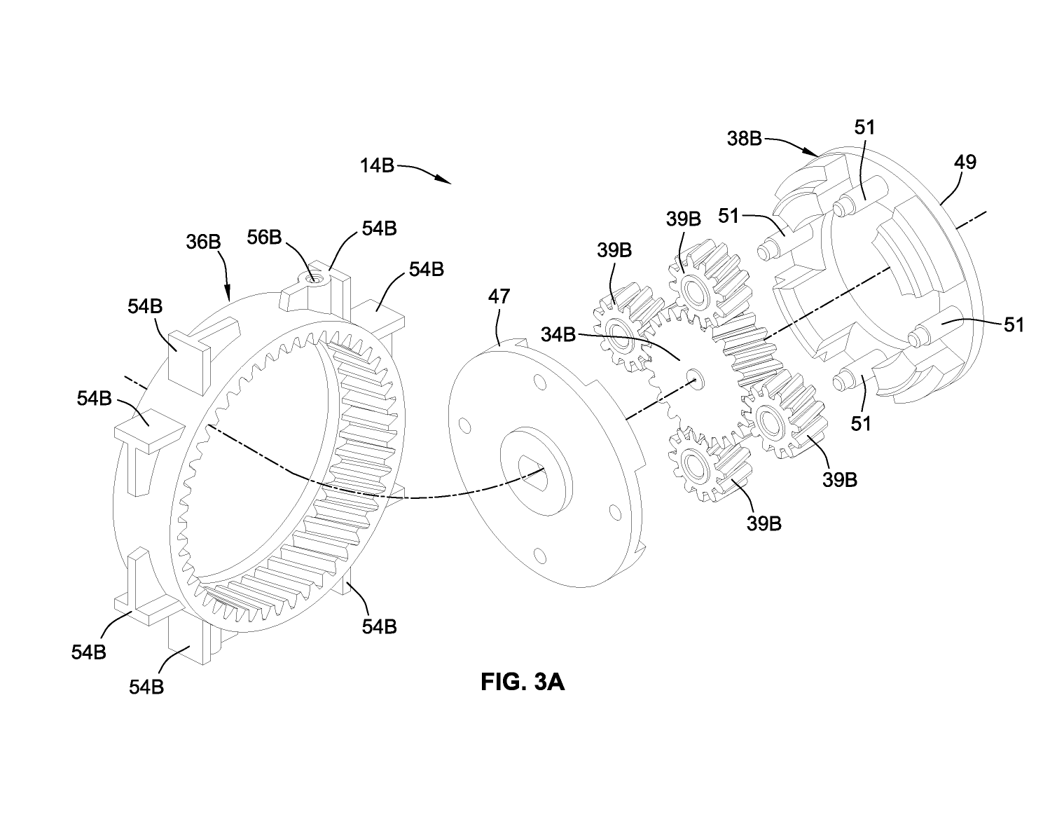

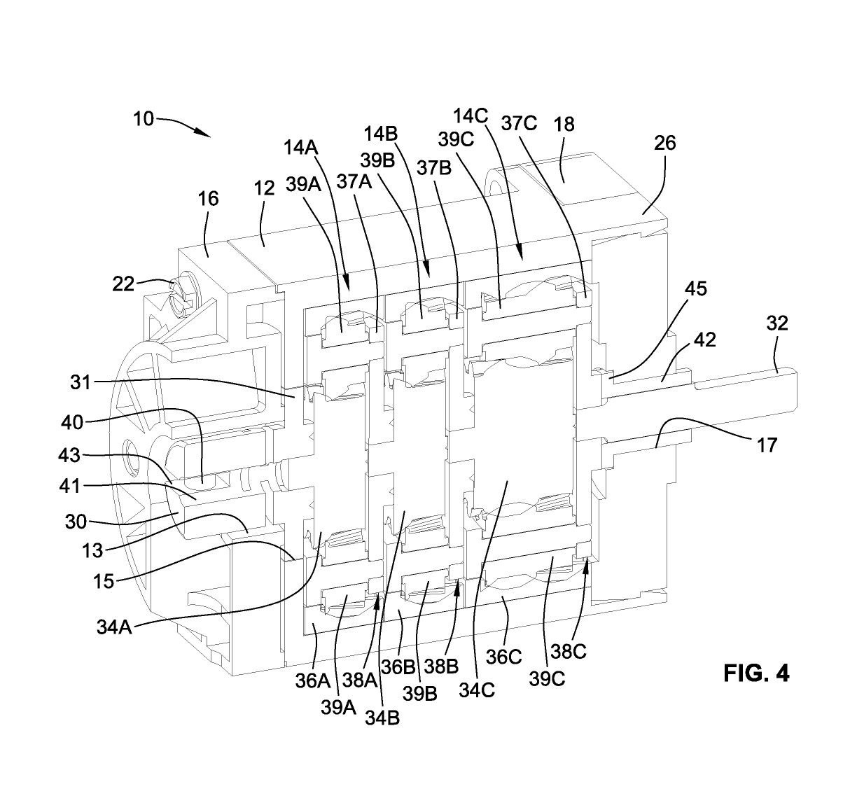

As seen in FIG. 4, the input coupler 30 passes longitudinally through a first coupler hole 13, which extends through a centrally located section of the motor mounting lid 16, and longitudinally through a second coupler hole 15, which extends through a centrally located section of the front face of the gearbox housing 12, and couples (e.g., via sonic welding) to a first “inner” gear member 34A of the first gear module 14A. Optionally, the input coupler 30 can mechanically couple to another gear member of the first gear module 14A. In this regard, if the order of gear modules 14A-C was changed, the input coupler 30 can mechanically couple to another one of the gear modules. A flange portion 31 of the input coupler 30, which is circumscribed by and seated inside of the second coupler hole 15 (the hole 15 and flange 31 having substantially equal diameters), is nested between the motor mounting lid 16 and the first gear module 14A such that the input coupler 30 is concentrically aligned for common rotation with the first “inner” gear member 34A. A hub portion 33 of the input coupler 30 is configured to operatively couple to any of a plurality of distinctly shaped and sized outputs shafts or other output members of various driving mechanism. In the illustrated embodiment, the hub portion 33 has a central cavity 41 with one or more notches 43 extending transversely therefrom which allow the hub 33 to expand and contract and thereby receive different shaped and sized shafts. An optional locking pin 40 (FIGS. 3 and 4) secures the output shaft of the driving mechanism inside the hub portion 33 of the input coupler 30.

The output coupler 32 passes longitudinally through a third coupler hole 17, which extends through a centrally located section of the output lid 18, and couples (e.g., is keyed and press-fit into) the center of a third “intermediate” gear member 38C of the third gear module 14C. Optionally, the output coupler 32 can mechanically couple to another gear member of the third gear module 14C or, if the order of the stack of gear modules 14A-C was changed, to another gear module altogether. An axial bearing 42, which circumscribes and attaches to a proximal portion of the output coupler 32, rotatably mounts the output coupler 32 inside the third coupler hole 17 of the output lid 18. A flange portion 45 of the axial bearing 42 is circumscribed by and seated at least partially inside of a complementary portion of the third coupler hole 17; the complementary portion of the hole 17 and the flange 45 having generally equal diameters. The flange portion 45 is nested between the output lid 18 and the third gear module 14C such that the output coupler 32 is concentrically aligned for common rotation with the third “intermediate” gear member 38C. It is within the scope of this disclosure to employ radial, axial and other types of bearings at various locations within the assembly 10.

FIG. 3 provides a perspective-view illustration of selected segments of the planetary gear train of FIG. 1. In particular, the modular gearbox assembly 10 utilizes one or more epicyclic gear arrangements, preferably in the nature of three interconnected planetary-gear sets, to modify the torque output and/or rotational speed of the driving mechanism coupled to the assembly 10. With reference to both FIGS. 3 and 4, a first planetary gear set of the first gear module 14A comprises a first “outer” gear member 36A, typically designated as a “ring gear,” that circumscribes the first “inner” gear member 34A, which may be generally designated as a “sun gear”. A first “intermediate” gear member 38A comprises a first plurality of planet gears 39A (also referred to in the art as “pinion gears”) that are rotatably mounted on a first carrier member 37A, also known in the art as a “planet carrier”. As seen in FIG. 3, there are two planet gears 39A mounted on the planet carrier 37A. Each planet gear 39A is continuously meshingly engaged with both the ring gear member 36A and the sun gear member 34A. The first planetary gear set will typically have a first predetermined gear ratio (e.g., a 7.0-ratio first stage) and, thus, offer a specific torque ratio and speed ratio. As will be developed in further detail below, the ring gear 36A also acts as the module housing for the first gear module 14A—i.e., the ring gear and module housing are integrally formed as a single-piece structure—with the various gear members of the first planetary gear set being circumscribed or otherwise encased by the module housing. Optionally, the module housing and ring gear member may each be fabricated as separate parts that are thereafter joined or otherwise attached together.

With continuing reference to FIGS. 3 and 4, and particular attention being paid to FIG. 3A, a second planetary gear set of the second gear module 14B comprises a second “outer” gear member 36B (or “ring gear”) that circumscribes a second “inner” gear member 34B (or “sun gear”). A second “intermediate” gear member 38B comprises a second plurality of planet gears 39B that are rotatably mounted on a second carrier member 37B (or “planet carrier”). As seen in FIG. 3A, there are four planet gears 39B mounted on the planet carrier 37B. In the embodiment illustrated in FIG. 3A, the second planet carrier 37B is a bipartite construction with a circular face plate 47 that attaches (e.g., via press fit, sonic welding, adhesives, fasteners, etc.) to a ring-shaped rear mounting disk 49. The rear mounting disk 49 includes at least two and, in some preferred embodiments, at least four gear posts 51 that each rotatably supports thereon one of the planet gears 39B. The gear posts 51 and, thus, the planet gears 39B are spaced equidistant from one another around the rear mounting disk 49. Each planet gear 39A is continuously meshingly engaged with both the ring gear member 36A and the sun gear member 34A. The second planetary gear set will typically have a second predetermined gear ratio (e.g., a 4.0-ratio second stage) and, thus, offer a specific torque ratio and speed ratio, which may be similar to or distinct from the torque and speed ratios of the first planetary gear set. Similar to the first ring gear 36A, the second ring gear 36B acts as the module housing for the second gear module 14B, with the various gear members of the second planetary gear set being circumscribed or otherwise encased by the module housing. Optionally, the module housing and ring gear may each be fabricated as separate parts that are thereafter attached together.

Continuing with the above example, the third planetary gear set of the third gear module 14C comprises a third “outer” gear member 36C (or “ring gear”) that circumscribes a third “inner” gear member 34C (or “sun gear”). A third “intermediate” gear member 38C comprises a plurality of planet gears 39C that are rotatably mounted on a third carrier member 37C (or “planet carrier”). In the illustrated embodiment, there are four planet gears 39C mounted on the planet carrier 37C. Each planet gear 39C is continuously meshingly engaged with both the ring gear member 36C and the sun gear member 34C. The third planetary gear set will typically have a third predetermined gear ratio (e.g., a 3.0-ratio third stage) and, thus, offer a specific torque ratio and speed ratio, which may be similar to or distinct from the torque and speed ratios of the first and second planetary gear sets. Similar to the first and second gear modules 14A, 14B, the ring gear 36C acts as the module housing for the third gear module 14C, with the various gear members of the third planetary gear set being circumscribed or otherwise encased by the module housing. Optionally, the module housing and ring gear may each be fabricated as separate parts that are thereafter attached together. As shown for illustrative purposes in FIG. 4, the third gear module 14C of FIG. 4 is a “heavy duty stage” wherein each of the gear members of that module is thicker than the corresponding members of other two gear modules 14A and 14B.

Once assembled, the input coupler 30 is rigidly attached (e.g., via sonic welding and/or keyed shaft) for common rotation with the first inner gear member 34A of the first gear module 14A. The first intermediate gear member 38A of the first gear module 14A is rigidly attached (e.g., via sonic welding and/or keyed shaft) for common rotation with the second inner gear member 34B of the second gear module 14B. Likewise, the second intermediate gear member 38B of the second gear module 14B is rigidly attached (e.g., via sonic welding and/or keyed shaft) for common rotation with the third inner gear member 34C of the third gear module 14C. The third intermediate gear member 38C is rigidly attached (e.g., keyed and press-fit) for common rotation with the output coupler 32, as described above. Optionally, each of the gear modules 14A-14C can mechanically couple to a different gear member of the adjacent gear module than what is shown in the drawings. In this regard, the order of the gear modules 14A-C can be changed such that the modules mechanically couple to a different one or ones of the gear modules than what is shown in the drawings.

When the modular gearbox assembly 10 is assembled and, thus, the gear modules 14A-C are properly aligned and interconnected inside of gearbox housing 12, torque and rotational velocity can be transferred from the external driving mechanism into the gearbox housing 12 to the planetary gear train via the input coupler 30. The gear ratio of the planetary gear train increases or decreases the torque and/or rotational velocity of the driving mechanism, which is then transmitted to the driven mechanism via the output coupler 32. The gear ratio of the planetary gear train is directly correlated to the individual gear ratios of the constituent planetary gear sets. In the illustrated example, the 7.0-ratio first stage, 4.0-ratio second stage and 3.0-ratio third stage combine to provide a three-stage 84.0-ratio gear reduction assembly.

According to the illustrated embodiment, the three planetary gear sets each comprises a “simple” planetary gear set. However, one or more of the planetary gear sets described above can be either “simple”—e.g., comprising a single-pinion carrier assembly—or “compound”—e.g., comprising a multi-pinion carrier assembly. Compared to simple planetary gear sets, compound planetary gear sets have the advantages of larger gear ratios, higher torque-to-weight ratios, and more flexible configurations. Embodiments with long pinions are also possible. In the same vein, the intermeshed gears themselves may take on alternative configurations (e.g., spur, helical, spiral, etc.) with different structural characteristics (e.g., pitches, tooth counts, radii, thicknesses, etc.).

In some embodiments, one or more of the constituent parts of the gear modules 14A-C are common to each other (i.e., substantially structurally identical). For example, the module housings 36A-C are, in some configurations, structurally identical. Optionally, the outer periphery of the housings, including the coupling elements described below (e.g., the flanges 54A-B of FIG. 1), are structurally identical for all of the gear modules, while the internal ring gear (e.g., number of teeth, pitch, etc.) are different. Another optional variation is that the coupling elements (e.g., flanges 54A-B) are identical for all of the gear modules, but the remaining aspects of the module housing differ. Moreover, the planet carrier configuration (e.g., the construction shown in FIG. 3A) can be “universal” to all of the gear modules in a given modular gearbox assembly or can be common among one or more of the gear modules in the assembly. For some preferred embodiments, it is desirable that each of the gear modules 14A-C be manufactured as a preassembled, self-contained part such that the gear module can be inserted into and removed from the gearbox housing 12 as a unit (i.e., the constituent parts of each planetary gear set are not assembled piecemeal into the gearbox housing 12).

The gearbox housing 12 of the modular gearbox assembly 10 is designed to stow and couple with various assortments and numerous arrangements of the interchangeable gear modules 14A-C such that the assembly 10 can provide any of a number of desired speed and torque ratios. The gearbox housing 12, for example, has one or more protrusions (and/or depressions, e.g., slots, channels, etc.) for operatively aligning, guiding, and retaining within the housing 12 the one or more gear modules 14A-C. The one or more protrusions are represented herein by a plurality of elongated rails (e.g., first, second, third and fourth rails 50A-D, respectively, of FIG. 1) and a plurality of elongated ribs (e.g., first and second sets of ribs generally designated as 52A and 52B, respectively, in FIG. 1), all of which project radially inward from an inner surface of the gearbox housing 12 and extend longitudinally along the length of the housing 12 (i.e., from the front end to the back end). Only two sets of ribs are visible in FIG. 1; however, there is a corresponding set of ribs projecting radially inward from the inner surface of the gearbox housing 12 on the opposite side of each set of ribs 52A, 52B seen in FIG. 1. It is within the scope of this disclosure to increase or decrease the number of rails and/or ribs from that which is shown in the drawings. It is also conceivable to omit the ribs (or the rails) altogether and utilize only the rails (or the ribs). In at least some implementations, these rails and/or protrusions are employed for location and fit for the gear modules to help ensure there is an accurate location consistency for centering of the modules. However, since some configurations do not use a through shaft from the motor, for example, a degree of misalignment is allowed without experiencing significant drive and/or reduction ratio loss.

Each of the gear module housings 36A-C has one or more coupling elements for mating with the aforementioned protrusions (and/or depressions) to thereby retain the gear modules 14A-C inside the gearbox housing 12. By way of example, and not limitation, the one or more coupling elements are represented in the drawings by a first plurality of flanges 54A which project radially outward from the outer periphery of the first module housing 36A and a second plurality of flanges 54B which project radially outward from the outer periphery of the second module housing 36B. Each flange 54A-B is shown as a substantially or completely flat plate with a reinforcement arm projecting orthogonally therefrom. Each of the flanges 54A-B is positioned and oriented to align with and press against at least one of the rails 50A-D and thereby operatively align the gear module 14A-B inside the gearbox housing 12. It is within the scope of this disclosure to increase or decrease the number of flanges on one or more or all of the module housings. Alternative flange shapes, dimensions, locations and orientations from what is shown in the drawings are also within the scope and spirit of this disclosure.

Once the gear modules 14A-C are inserted into the gearbox housing 12, the protrusions 50A-D, 52A-B mate with the coupling elements 54A-B to thereby retain the gear modules 14A-C inside the gearbox housing 12. In accord with the illustrated embodiment, each set of ribs 52A-B of the gearbox housing 12 is designed to fit in between two opposing reinforcement arms of adjacent flanges 54A-B of a module housing 36A-B. In addition, the flat plate of each flange 54A-B presses against a corresponding rail 50A-D of the gearbox housing 12. The rails 50A-D and ribs 52A-B cooperate with the flanges 54A-B in the manner heretofore described to: (1) ensure that the gear modules 14A-B are properly oriented prior to being inserted into the gearbox housing 12; (2) guide the gear modules 14A-C into and out of the gearbox housing 12; and (3) prevent the module housings/ring gears 36A-B of the gear modules 14A-B from rotating. This configuration also allows the gear modules 14A-C to be assembled inside of the gearbox housing 12 between the input and output couplers 30, 32 in any of a variety of different arrangements (e.g., the third gear module 14C could be positioned in the middle or at the front end of the stack, while the first gear module 14A could be positioned in the middle or at the rear end of the stack). In some embodiments, one or more of the flanges 54A-B on each of the module housings 36A-B includes a fastener slot 56A-B that is configured to receive therein a complementary fastener (e.g., a screw 20) to thereby lock the gear module 14A-B inside the gearbox housing 12.

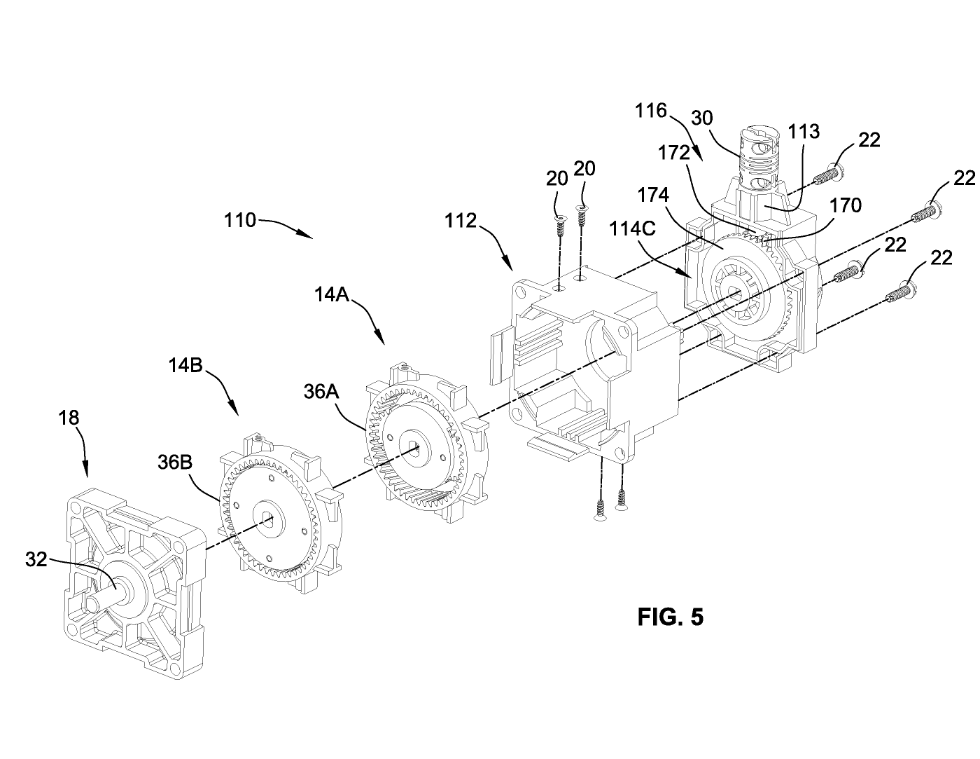

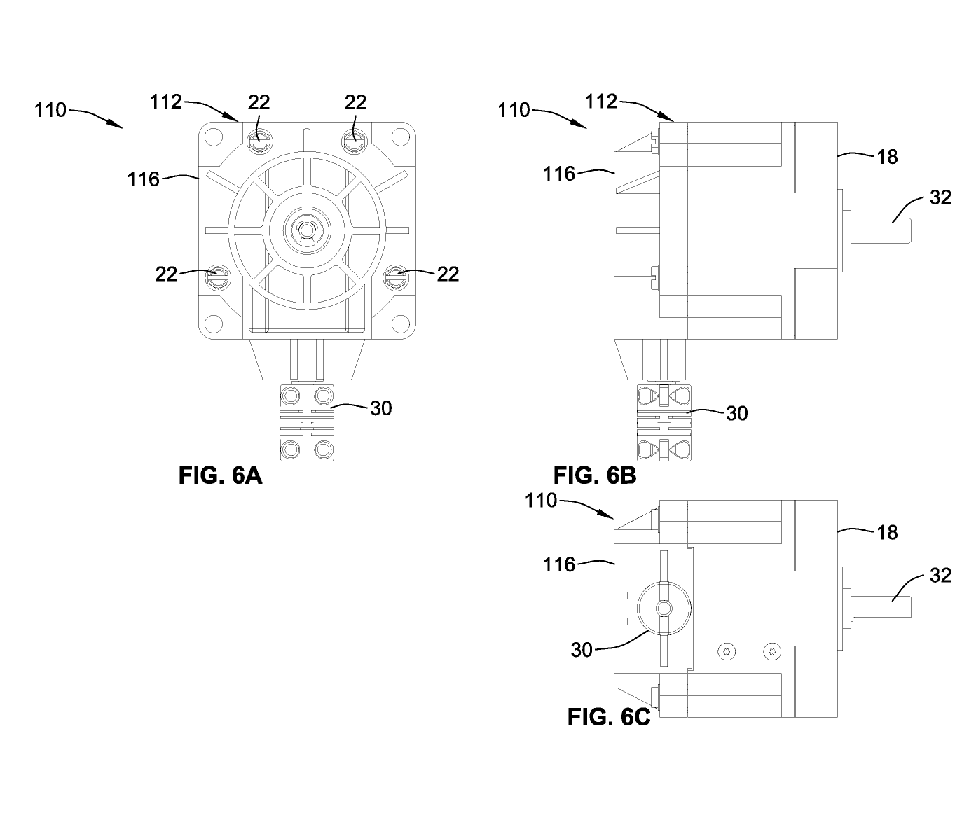

Other aspects of this disclosure are directed to gearbox kits for assembling a gearbox assembly that is operable to receive, modify and transmit the power output of a driving mechanism. As indicated above, the illustrated components of the modular gearbox assembly 10 presented in FIG. 1 may be representative of some or all of the components that are included in a representative gearbox kit in accordance with the present disclosure. In this regard, the gearbox assembly that is assembled from each kit, including its constituent parts, can include any of the options, features and alternatives described herein. It is also within the scope and spirit of this disclosure that the kit include additional, fewer or alternative components from those shown in FIG. 1. For example, each kit may include an assortment or gear modules (e.g., more than the three shown in FIG. 1) with assorted predetermined gear ratios, some of which may be distinct and some of which may be identical, and various configurations (e.g., standard duty, heavy duty, plastic, metal, composite, etc.). A kit may also, or alternatively, provide the necessary componentry to assemble a bevel-gear-type modular gearbox assembly, including any of the features described below with respect to FIGS. 5-7.

A representative gearbox kit contains, for example, a plurality of self-contained gear modules, such as the first, second and third gear modules 14A, 14B and 14C of FIG. 1, each of which includes a gear train (e.g., a planetary gear set) that is encased by a module housing (e.g., module housings/ring gears 36A-C). The gear train of each self-contained gear module includes intermeshed gear elements (e.g., a ring gear, a sun gear, and a plurality of planet gears) that cooperatively provide a predetermined gear ratio, which will correlate to a specific speed ratio and torque ratio. Like the gear modules illustrated in FIGS. 1-4, the module housing of each gear module in the kit will have one or more coupling elements, such as the flanges 54A-B of FIG. 1, for operatively attaching to a gearbox housing.

Each kit will also include at least one and, in some implementations, multiple gearbox housings, such as gearbox housing 12 of FIG. 1, gearbox housing 112 of FIG. 5, or any of the other housings disclosed herein. The kit also provides at least one input coupler (e.g., the flexible beam coupler 30 of FIG. 1) for attaching to a driving mechanism and transmitting the power output therefrom to the gear module(s) stowed inside the housing such that the power output is modified by the gear module(s). Also provided is at least one output coupler (e.g., the keyed shaft 32 of FIG. 1) for outputting from the gearbox housing the modified power output. Each housing in the kit is configured to stow therein any of the self-contained gear modules provided in the kit. By way of non-limiting example, the gearbox housing may include one or more protrusions, such as the elongated rails 50A-D and the ribs 52A-B of FIG. 1, that project radially inward from an inner surface of the housing. These protrusions are configured to mate with the coupling elements of each gear module housing to thereby attach the gearbox housing to the gear module(s).

Improved methods for assembling a gearbox assembly and improved methods for using a gearbox assembly are described below in accordance with aspects of the present disclosure. These methods will be described with reference to the various aspects and features shown in FIGS. 1-4 of the drawings. It should be readily recognized, however, that such reference is being provided purely by way of explanation and clarification, and not by way of limitation.

In accordance with one embodiment, a method is presented for assembling a gearbox assembly (e.g., modular gearbox assembly 10 of FIG. 1) that is operable to receive power output from a driving mechanism, such as an electric motor, modify the power output, and transmit the modified power output to a driven mechanism, such as a pump or compressor. This method includes identifying a desired gearbox gear ratio, which may comprise calculating a desired gearbox ratio or receiving a desired gearbox gear ratio from an end user. The method then includes selecting one or more gear modules (e.g., gear modules 14A-C of FIG. 1) from a plurality of available preassembled, self-contained gear modules (e.g., any of the gear modules disclosed herein and/or illustrated in the drawings) that have been determined to provide the desired gearbox gear ratio. Each self-contained gear module comprises a module housing (e.g., module housings/ring gears 36A-C) with a gear train (e.g., a planetary gear set) that is encased by the module housing. The gear train includes two or more intermeshed gear elements (e.g., planet gears continuously intermeshed with a sun gear and a ring gear) which provide a predetermined gear ratio. Like the module housings 36A-B disclosed in FIG. 1, the module housing of each selected gear module has one or more coupling elements projecting radially outward therefrom.

This method also includes selecting a gearbox housing (e.g., gearbox housing 12) from a plurality of available gearbox housings (e.g., any of the gearbox housings disclosed herein and/or illustrated in the drawings), the selected gearbox housing having been determined to be shaped and sized to stow therein the selected gear modules. The gearbox housing has an inner surface with one or more protrusions projecting radially inward therefrom, the protrusions being configured to mate with the coupling elements of the module housing(s) to thereby attach the gearbox housing to the selected gear module(s). The method further comprises inserting the selected self-contained gear module(s) into the gearbox housing such that the gear modules successively mechanically couple with one another and such that the coupling element(s) mate with the protrusion(s). The method may then include attaching at least one lid (e.g., the motor mounting lid 16 and/or output lid 18 of FIG. 1) to the open end or ends of the gearbox housing.

The method may further comprise attaching an input coupler (e.g., flexible beam coupler 30) and/or an output coupler (keyed shaft 32) to the gearbox housing. The input coupler is configured to attach to the driving mechanism and transmit the power output therefrom to the gear module(s) stowed in the gearbox housing. In contrast, the output coupler is configured to output from the gearbox housing the modified power output. In some embodiments, the module housings of some or all of the self-contained gear modules are structurally identical. In some embodiments, the predetermined gear ratios of some or all of the self-contained gear modules are distinct. In some embodiments, the protrusions are rails that extend longitudinally along the length of the gearbox housing, and the coupling elements are flanges which abut the rails and operatively align the gear module inside the gearbox housing.

In some embodiments, the method includes at least those steps enumerated above. It is also within the scope and spirit of the present invention to omit steps, include additional steps, and/or modify the order presented above. It should be further noted that the above method can be representative of a single sequence for assembling a gearbox assembly. However, it is expected that the method will be practiced in a systematic and repetitive manner to assembly multiple gearbox assemblies.

Turning next to FIG. 5, illustrated therein is a representative 3-stage bevel-gear-type modular gearbox assembly 110 according to aspects of the present disclosure. Although differing in appearance, the modular gearbox assembly 110 can be similar in function and operation to the modular gearbox assembly 10 discussed above with respect to FIGS. 1-4 and, thus, can include many of the options, features and alternatives described above (and vice versa). For example, the output lid 18, the gear modules 14A, 14B, the input coupler 30, and the output coupler 32 of FIG. 5 can be structurally similar or structurally identical to their corresponding counterparts illustrated in FIG. 1. As such, for brevity and conciseness, these components will not be described again.

In the embodiment presented in FIG. 5, the modular gearbox assembly 110 includes a rigid outer housing 112 (or “gearbox housing”) with a plurality of sidewalls that are interconnected to define therebetween a mounting space within which are mounted and stowed one or more planetary-gear inserts (or “stages”) —i.e., first and second gear modules 14A and 14B. Attached at an input (“front”) end of the gearbox housing 112 is a motor mounting lid 116, while attached on the opposite side of the gearbox housing 112 at an output (“rear”) end thereof is an output lid 18. As shown, the motor mounting lid 116 is attached to the gearbox housing 112 via one or more threaded fasteners, which may be in the nature of four flat-head bolts 22. Once attached, each lid 116, 18 at least partially (or substantially) covers a respective open end of the gearbox housing 112 such that the lids 116, 18 cooperatively secure the gear modules 14A-B inside the housing 112.

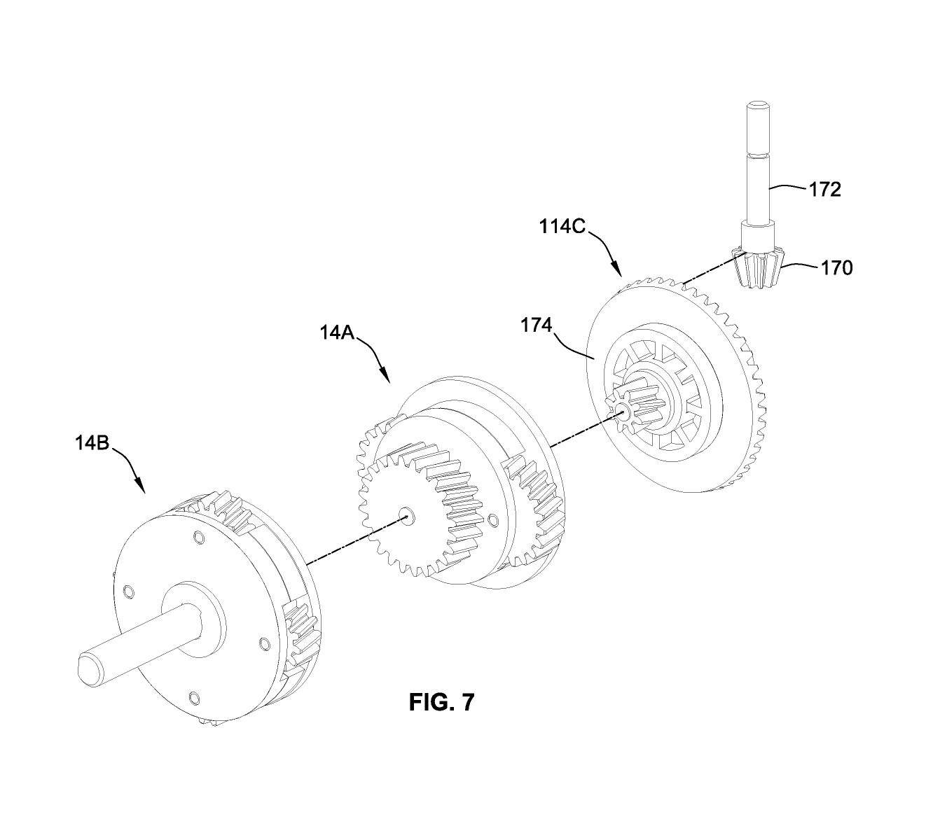

FIG. 7 provides a perspective-view illustration of selected segments of the planetary gear train of FIG. 5. Like the modular gearbox assembly 10 of FIG. 1, the modular gearbox assembly 110 of FIG. 5 utilizes one or more epicyclic gear arrangements, preferably in the nature of interconnected planetary-gear sets, to modify the torque output and/or rotational speed of the driving mechanism coupled to the assembly 110. As described above with respect to FIGS. 3 and 4, the first gear module 14A of FIG. 7 includes a first planetary gear set with a first “outer” gear member (e.g., ring gear 36A) that circumscribes a first “inner” gear member (e.g., sun gear 34A), and a first “intermediate” gear member (e.g., gear member 38A) with a plurality of planet gears (e.g., pinion gears 39A) that are rotatably mounted on a carrier member (e.g., planet carrier 37A). The first planetary gear set will typically have a predetermined gear ratio (e.g., a 7.0-ratio second stage) and, thus, offer a specific torque ratio and speed ratio. In this regard, the second gear module 14B of FIG. 7 includes a second planetary gear set with a second “outer” gear member (e.g., ring gear 36B) that circumscribes a second “inner” gear member (e.g., sun gear 34B), and a second “intermediate” gear member (e.g., gear member 38B) with a plurality of planet gears (e.g., pinion gears 39B) that are rotatably mounted on a carrier member (e.g., planet carrier 37B). The second planetary gear set will typically have a predetermined gear ratio (e.g., a 3.0-ratio third stage) and, thus, offer a specific torque ratio and speed ratio.

In contrast to the embodiment set forth in FIG. 1, the modular gearbox assembly 110 of FIGS. 5-7 includes a bevel gear stage 114C with a bevel pinion 170 that is continuously intermeshed with a bevel gear 174, which is axially offset from the bevel pinion 170, for example, by 90 degrees. In the illustrated embodiment, the input coupler 30 is attached (e.g., via sonic welding or locking pin) to a proximal end of an input shaft 172 for common rotation therewith. The input shaft 172, in turn, passes through an input chute 113 which projects from a lateral (“top”) surface of the bevel-gear motor mounting lid 116. Rigidly attached at or integrally formed on a distal end of the input shaft 172, on the opposite side of the input coupler 30, is the bevel pinion 170. Comparatively, the bevel gear 174 is rotatably coupled to the motor mounting lid 116 via a bevel gear shaft (not visible in the views provided). The bevel gear 174 of the bevel gear stage 114C is rigidly attached (e.g., via sonic welding and/or keyed shaft) for common rotation with the inner (sun) gear member of the first gear module 14A, as seen in FIG. 7. The bevel gear stage 114C will typically have a predetermined gear ratio (e.g., a 4.6-ratio first stage) and, thus, offer a specific torque ratio and speed ratio. In the illustrated example, the 4.6-ratio first stage, 7.0-ratio second stage and 3.0-ratio third stage combine to provide a three-stage 96.6-ratio gear reduction assembly.

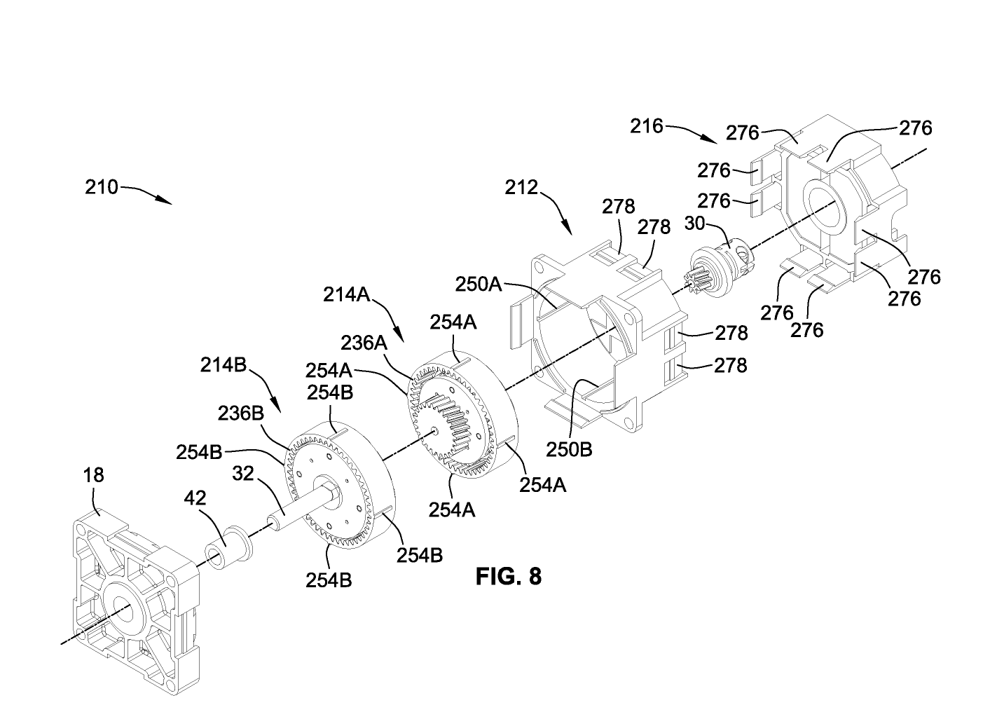

FIG. 8 illustrates a representative 2-stage spur-gear-type modular gearbox assembly, designated generally as 210, in accordance with aspects of the present disclosure. Although differing in appearance, the modular gearbox assembly 210 of FIG. 8 can be similar in function and operation to the modular gearbox assembly 10 of FIG. 1 and/or the modular gearbox assembly 110 of FIG. 5 and, thus, can include many of the options, features and alternatives described above (and vice versa). In general, the only component from the 3-stage spur-gear-type modular gearbox assembly 10 of FIG. 1 that needs to be modified to offer a 2-stage spur-gear-type modular gearbox assembly is the gearbox housing 12—namely, the housing length needs to be shortened to accommodate only two gear modules. Otherwise, all of the other components can be structurally identical.

FIG. 8 presents some optional features and variations that can be incorporated into some, any or all of the disclosed embodiments. For instance, the motor mounting lid 216 of FIG. 8 includes one or more mechanical couplings for securely attaching the lid 216 to the gearbox housing 212. These mechanical couplings may be in the nature of at least two or, as shown, eight circumferentially spaced snap fasteners 276, each of which projects forward from the front end of the lid 216. Each snap fastener 276 passes over the ramped surface of and latches onto a complementary recess 278 (only four of the eight of which are visible in FIG. 8) on the outer periphery of the gearbox housing 212.

Like the gearbox housing 12 of FIG. 1, the gearbox housing 212 of the modular gearbox assembly 210 of FIG. 8 is designed to stow and couple with various assortments and numerous arrangements of the interchangeable gear modules 214A-B such that the assembly 210 can provide any of a number of desired speed and torque ratios. The gearbox housing 212, for example, has one or more elongated channels 250A and 250B extending longitudinally along the length thereof for operatively aligning, guiding, and retaining within the housing 212 the two gear modules 214A-B. Notably, only two channels 250A-B are visible in FIG. 8; however, a corresponding channel is located on the inner surface of the housing 212 on the opposite side of each channel shown in FIG. 8. Projecting radially outward from the outer periphery of each module housing 236A and 236B is a plurality elongated ribs 254A and 254B, respectively. Once the gear modules 214A-B are inserted into the gearbox housing 212, the ribs 254A-B insert into the channels 250A-B to thereby retain the gear modules 214A-B inside the gearbox housing 212.

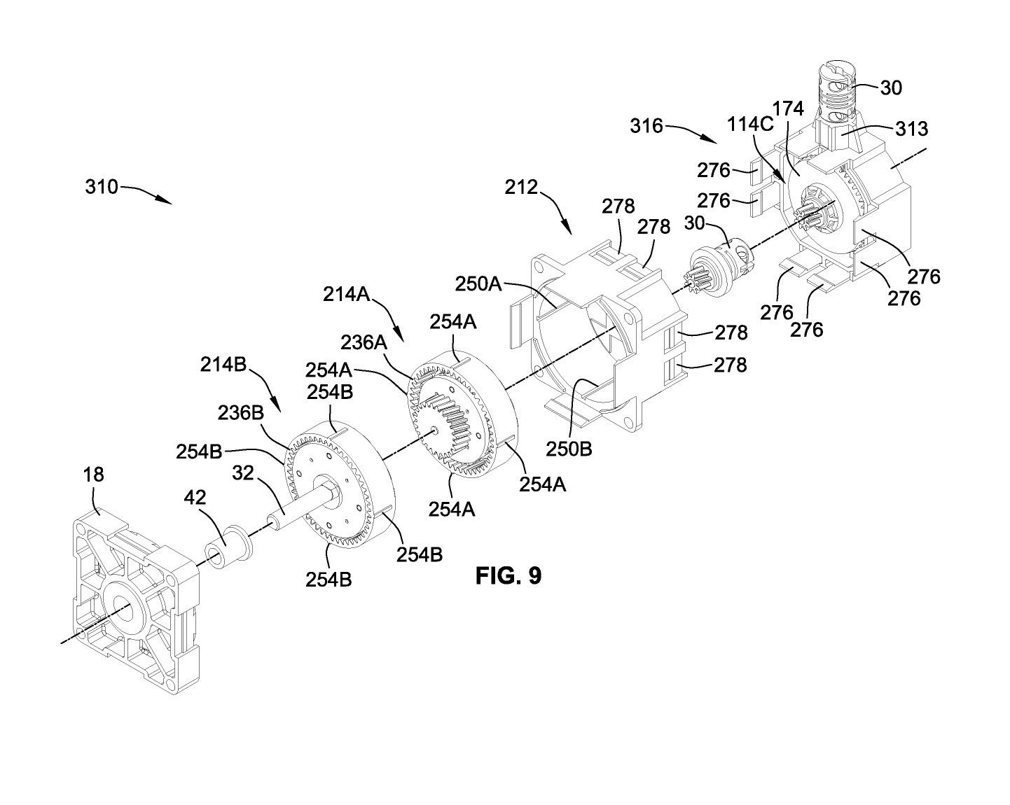

FIG. 9 illustrates a representative 2-stage bevel-gear-type modular gearbox assembly, designated generally as 310, in accordance with aspects of the present disclosure. Although differing in appearance, the modular gearbox assembly 310 of FIG. 9 can be similar in function and operation to the modular gearbox assemblies 10, 110 and/or 210, and therefore can include many of the options, features and alternatives described above (and vice versa). In general, the only component from the bevel-gear-type modular gearbox assembly 110 of FIG. 5 that needs to be modified to offer a 2-stage bevel-gear-type modular gearbox assembly is the gearbox housing 112—namely, the housing length needs to be shortened to accommodate only two gear modules. Otherwise, all of the other components can be structurally identical.

As shown, the 2-stage bevel-gear-type modular gearbox assembly 210 can be an amalgamation of components from the other disclosed embodiments. For example, the modular gearbox assembly 310 utilizes the output lid 18, the input coupler 30, the output coupler 32 and axial bearing 42 of FIG. 1, the bevel gear stage 114C of FIG. 5, and the gearbox housing 212 and gear modules 214A-B of FIG. 8. The motor mounting lid 316 of FIG. 9 can be considered to be substantially identical to the motor mounting lid 216 of FIG. 8, with the exception of the input chute 313 which projects from a lateral (“top”) surface of the bevel-gear motor mounting lid 316.

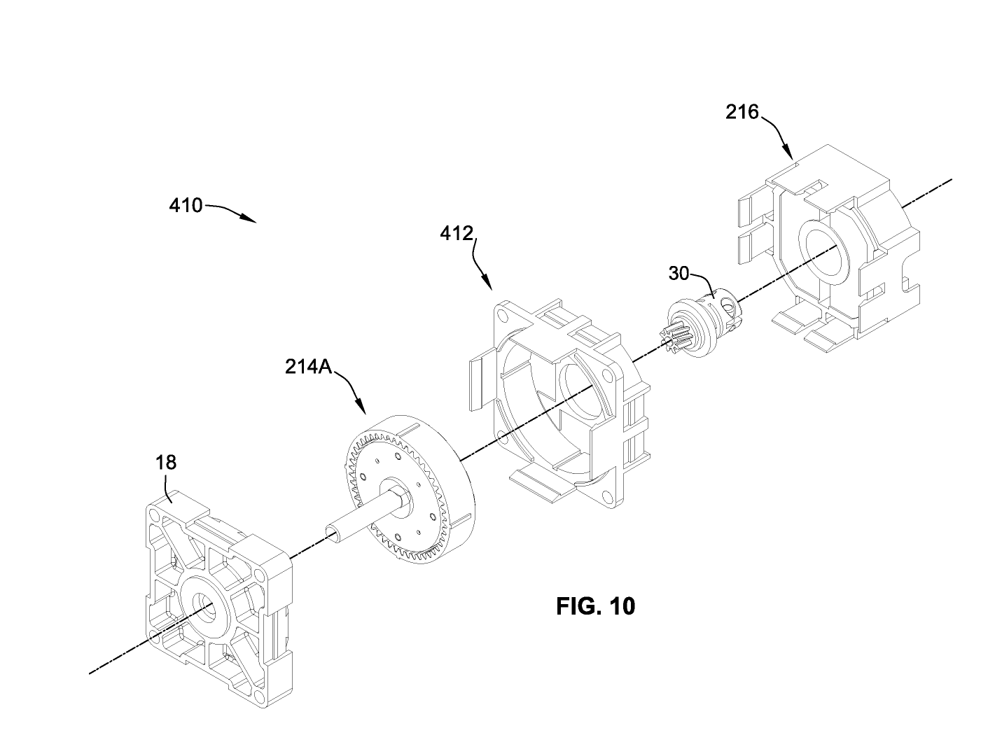

FIG. 10 illustrates a representative 1-stage spur-gear-type modular gearbox assembly, designated generally as 410, in accordance with aspects of the present disclosure. Although differing in appearance, the modular gearbox assembly 410 of FIG. 10 can be similar in function and operation to the modular gearbox assemblies disclosed above and, thus, can include many of the options, features and alternatives described above (and vice versa). Generally speaking, the only component from the 2-stage spur-gear-type modular gearbox assembly 210 of FIG. 8 that needs to be modified to offer a 1-stage spur-gear-type modular gearbox assembly is the gearbox housing 212—namely, the gearbox housing 412 of FIG. 10 is structurally similar to the gearbox housing 212 of FIG. 8 except the length of the gearbox housing 412 is shortened to accommodate only one gear module. Otherwise, all of the other components can be structurally identical.

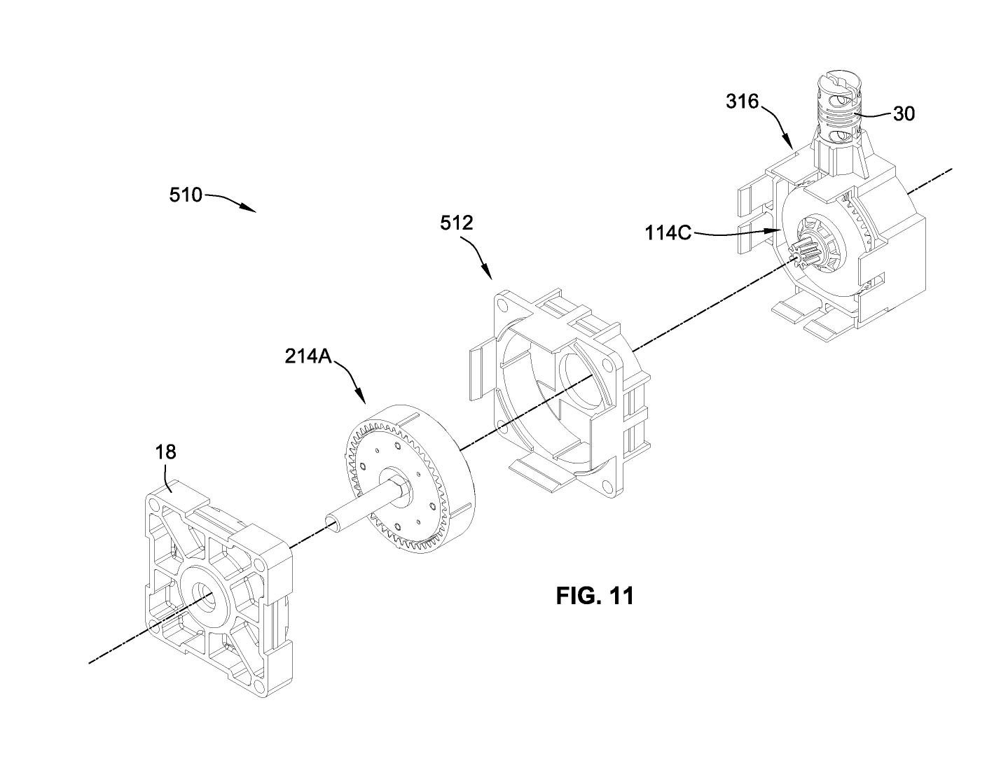

FIG. 11 illustrates a representative 1-stage bevel-gear-type modular gearbox assembly, designated generally as 510, in accordance with aspects of the present disclosure. Although differing in appearance, the modular gearbox assembly 510 of FIG. 11 can be similar in function and operation to the modular gearbox assemblies disclosed above and, thus, can include many of the options, features and alternatives described above (and vice versa). In general, the only component from the 2-stage bevel-gear-type modular gearbox assembly 310 of FIG. 9 that needs to be modified to offer a 1-stage bevel-gear-type modular gearbox assembly is the gearbox housing 212—namely, the gearbox housing 512 of FIG. 111 is structurally similar to the gearbox housing 212 of FIG. 9 except the length of the gearbox housing 514 is shortened to accommodate only a single gear module. Otherwise, all of the other components can be structurally identical.

While many embodiments and modes for carrying out the present invention have been described in detail above, those familiar with the art to which this invention relates will recognize various alternative designs and embodiments for practicing the invention within the scope of the appended claims.

What is claimed is:

1. A modular gearbox assembly for transmitting the power output of a driving mechanism to a driven mechanism, the modular gearbox assembly comprising:
one or more gear modules each comprising a module housing with a gear train encased by the module housing, the gear train including a plurality of intermeshed gear elements providing a predetermined gear ratio, the module housing having one or more coupling elements projecting radially outward therefrom; and
a gearbox housing stowing therein the one or more gear modules, the gearbox housing having an input coupler configured to attach to the driving mechanism and transmit the power output therefrom to the one or more gear modules such that the power output is modified by the one or more gear modules, the gearbox housing also having an output coupler configured to attach to the driven mechanism and transmit thereto the modified power output from the one or more gear modules, the gearbox housing having an inner surface with one or more protrusions projecting radially inward therefrom, the one or more protrusions mating with the one or more coupling elements to thereby retain the one or more gear modules in the gearbox housing.

2. The modular gearbox assembly of claim 1, wherein the one or more gear modules comprises a plurality of gear modules, the predetermined gear ratio of the intermeshed gear elements of each of the gear modules being distinct from the other gear modules.

3. The modular gearbox assembly of claim 2, wherein the plurality of gear modules are configured to be assembled inside of the gearbox housing between the input and output couplers in any of a plurality of arrangements.

4. The modular gearbox assembly of claim 2, wherein the module housings of the plurality of gear modules are at least substantially structurally identical.

5. The modular gearbox assembly of claim 1, wherein each of the one or more gear modules is a preassembled, self-contained part such that the gear module can be inserted into and removed from the gearbox housing as a unit.

6. The modular gearbox assembly of claim 1, wherein the one or more protrusions each comprises a rail extending longitudinally along the length of the gearbox housing.

7. The modular gearbox assembly of claim 6, wherein the one or more coupling elements each comprises a flange which abuts at least one of the rails and operatively aligns the gear module inside the gearbox housing.

8. The modular gearbox assembly of claim 7, wherein at least one of the flanges includes a fastener slot configured to receive therein a complementary fastener to thereby lock the gear module inside the gearbox housing.

9. The modular gearbox assembly of claim 1, further comprising a motor mounting lid attached to and at least partially covering a first open end of the gearbox housing, the input coupler passing through the motor mounting lid.

10. The modular gearbox assembly of claim 9, further comprising an output lid attached to and at least partially covering a second open end of the gearbox housing on the opposite side of the first end, the output coupler passing through the output lid.

11. The modular gearbox assembly of claim 1, wherein the driving mechanism is any of a plurality of motors or engines, or both, each having a distinctly shaped output shaft, and wherein the input coupler includes a hub with a shaft slot configured to receive therein and couple to any of the distinctly shaped output shafts.

12. The modular gearbox assembly of claim 1, wherein the output coupler includes an output shaft mechanically coupled to the one or more gear modules.

13. The modular gearbox assembly of claim 1, wherein the gear train is a planetary gear set, and the gear elements include a plurality of planet gears intermeshed with a sun gear and a ring gear.

14. The modular gearbox assembly of claim 1, wherein at least one of the one or more gear modules is fabricated from a combination of metallic and polymeric materials.

15. A gearbox kit for assembling a gearbox assembly operable to receive, modify and transmit the power output of a driving mechanism, the gearbox kit comprising:
a plurality of self-contained gear modules each comprising a module housing with a gear train encased by the module housing, the gear train including two or more intermeshed gear elements providing a predetermined gear ratio, the module housing having one or more coupling elements projecting radially outward therefrom; and
a gearbox housing configured to stow therein any one or more of the self-contained gear modules, the gearbox housing having an input coupler configured to attach to the driving mechanism and transmit the power output therefrom to the one or more gear modules such that the power output is modified by the one or more gear modules, the gearbox housing also having an output coupler configured to output from the gearbox housing the modified power output, the gearbox housing having an inner surface with one or more protrusions projecting radially inward therefrom, the one or more protrusions being configured to mate with the one or more coupling elements to thereby retain the one or more gear modules in the gearbox housing.

16. A method for assembling a gearbox assembly operable to receive power output from a driving mechanism, modify the power output, and transmit the modified power output to a driven mechanism, the method comprising:
identifying a desired gearbox gear ratio;
selecting one or more gear modules from a plurality of preassembled, self-contained gear modules determined to provide the desired gearbox gear ratio, each of the self-contained gear modules comprising a module housing with a gear train encased by the module housing, the gear train including two or more intermeshed gear elements providing a predetermined gear ratio, the module housing having one or more coupling elements projecting radially outward therefrom;
selecting a gearbox housing from a plurality of gearbox housings which is determined to be configured to stow therein the selected one or more self-contained gear modules, the gearbox housing having an inner surface with one or more protrusions projecting radially inward therefrom, the one or more protrusions being configured to mate with the one or more coupling elements to thereby retain the one or more gear modules in the gearbox housing;
inserting the selected one or more self-contained gear modules into the gearbox housing such that the gear modules successively mechanically couple with one another and such that the one or more coupling elements mate with the one or more protrusions; and
attaching at least one lid to at least one end of the gearbox housing.

17. The method of claim 16, further comprising attaching an input coupler and an output coupler to the gearbox housing, the input coupler being configured to attach to the driving mechanism and transmit the power output therefrom to the one or more gear modules, and the output coupler being configured to output from the gearbox housing the modified power output.

18. The method of claim 16, wherein the module housings of the plurality of self-contained gear modules are structurally identical, and the predetermined gear ratio of the intermeshed gear elements of each of the plurality of self-contained gear modules is distinct.

19. The method of claim 16, wherein the one or more protrusions each comprises a rail extending longitudinally along the length of the gearbox housing, and wherein the one or more coupling elements each comprises a flange which abuts at least one of the rails and operatively aligns the gear module inside the gearbox housing.

20. The method of claim 16, wherein the attaching at least one lid includes attaching a motor mounting lid to a first end of the gearbox housing, and attaching an output lid to a second end of the gearbox housing.
